(19) United States
(12) Patent Application Publication
(10) Pub. No.: US 2022/0405293 A1
(43) Pub. Date: Dec. 22, 2022

(54) METHODS TO GENERATE UNIQUE RESOURCE IDENTIFIERS

(71) Applicant: salesforce.com, inc., San Francisco, CA (US)

(72) Inventor: Hendrik Lipka, Jena (DE)

(21) Appl. No.: 17/351,696

(22) Filed: Jun. 18, 2021

(51) Int. Cl. G06F 16/25; G06F 16/2455; G06F 16/242; G06F 40/205; G06F 16/21

(52) U.S. Cl. CPC G06F 16/252; G06F 16/24552; G06F 16/243; G06F 40/205; G06F 16/24564; G06F 16/21

(57) ABSTRACT

Methods, systems, and devices for generating a unique resource identifier are described. According to the techniques described herein, a device (e.g., an application server) may receive a natural language query indicating a query for a value of one or more data records stored in a database table. The database table may be accessible via a target application program interface (API) that is configured as a resource-oriented API. The device may parse the natural language query to identify a set of resources and a set of values corresponding to the set of resources. The device may then identify a hierarchy of the set of resources of the target API and generate the unique resource identifier for the target API to access the value of the one or more data records. The device may generate the unique resource identifier based on the hierarchy of the set of resources.

### FIELD OF TECHNOLOGY

The present disclosure relates generally to database systems and data processing, and more specifically to methods to generate unique resource identifiers.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A user may use the cloud platform to query for a tenant's data and extract meaningful information. In some systems, the user may use a specific format or specific terms to query the tenant's data. For example, data may be stored and accessible via a representational state transfer (REST) application program interface (API).

### BRIEF DESCRIPTION OF THE DRAWINGS

FIG. 1 illustrates an example of a system that supports methods to generate unique resource identifiers in accordance with aspects of the present disclosure.

FIG. 2 illustrates an example of a computing system that supports methods to generate unique resource identifiers in accordance with aspects of the present disclosure.

FIG. 3 illustrates an example of a computing system that supports methods to generate unique resource identifiers in accordance with aspects of the present disclosure.

FIG. 4 illustrates an example of a process flow that supports methods to generate unique resource identifiers in accordance with aspects of the present disclosure.

FIG. 5 shows a block diagram of an apparatus that supports methods to generate unique resource identifiers in accordance with aspects of the present disclosure.

FIG. 6 shows a block diagram of a unique resource identifier generation component that supports methods to generate unique resource identifiers in accordance with aspects of the present disclosure.

FIG. 7 shows a diagram of a system including a device that supports methods to generate unique resource identifiers in accordance with aspects of the present disclosure.

FIGS. 8 through 11 show flowcharts illustrating methods that support methods to generate unique resource identifiers in accordance with aspects of the present disclosure.

### DETAILED DESCRIPTION

A tenant of a multi-tenant database may store information and data for users, customers, organizations, etc. in a database. For example, the tenant may manage and store data and metadata for exchanges, opportunities, deals, assets, customer information, and the like. The tenant may query the database in ways to extract meaningful information from the data, which may assist the tenant in future decision making and analysis. In some cases, a report may include the data query and an appropriate title which describes the queried data in terms and conventions often used by the tenant. These reports, queries, and interactions, as well as corresponding metadata, may also be stored in the databases. A user may be able to combine or cross-analyze multiple reports to further extract meaningful data and information.

A database system may support storing data such that the stored data is accessible via representational state transfer (REST) application program interface (API). In particular, many computer systems expose their data in the form of REST APIs. REST APIs are designed as resource oriented APIs, where each resource (e.g. a customer data record, or an order record, or the line item of an order) is assigned a unique resource identifier. These unique resource identifiers are built such that an identifier for a parent record (e.g. the order) is the prefix of the unique resource identifier of its child records (e.g., line items). A database administrator or user may not be able to use REST APIs to extract data stored in a database, because the user may not know the specific format for a REST API query or may not know the structure of the data to compose the query, or for other reasons. To support querying data using REST APIs, possible natural language queries may be mapped to REST APIs. However, database systems may not provide for converting a natural language query to a REST API. As such, a method to connect REST APIs into natural command-based interfaces may provide for a relatively easy access of data stored in a database system.

Various aspects of the present disclosure provide techniques for utilization of various configurations to generate a unique resource identifier for a target API in response to receiving a query from a user. In particular, the aspects depicted herein is directed to generating unique resource identifiers for REST APIs upon receiving a natural language query from a user. Techniques described herein may support a query generation using two methods. The methods may be used to automatically derive a unique resource identifier for a resource from a natural language query (e.g., command) inputted by a user in a command interface. The first method uses metadata to derive the unique resource identifier for a resource accessed by a REST API. The second method uses transformation rules to derive the unique resource identifier for a resource accessed by a REST API. Such techniques may improve the accuracy of query results, reduce system configuration time, and automatically adapt to changes in data usage patterns.

A server (e.g., a database server, an application server) of a database system may receive natural language queries (e.g., a submitted question, a submitted search phrase, etc.) and may use machine learning models to determine a unique resource identifier for a target API. In particular, the system (e.g., database server, application server) described herein may receive, via a user interface, a natural language query indicating a query for a value of a data record stored in a database. That is, a server may receive a natural language query indicating a query for a value of one or more data records stored in a database table. As depicted herein. the database table may be accessible via a target API that is configured as a resource oriented API. For example, the data resource may be accessed via a REST API (or a similarly configured API) configured as a resource oriented API. The database server may then parse the natural language query to identify a set of resources and a set of values corresponding to the set of resources. For instance, the database server may parse the natural language query to identify a set of resources of the target API and a set of values corresponding to the set of resources. The parsing operation may be based on a first configuration. In one example, the user may input a natural language query “show me the price of item 2 of order 42.” The server may parse the natural language query to identify the resources “order” and “item.” The server may also identify parameters related to each resource. That is, in the natural language query “show me the price of item 2 of order 42,” the server may determine that “2” is the value of the resource “item” and “42” is the value of the resource “order.”

The server then identifies a hierarchy of the set of resources of the target API. In some examples, the server may identify the hierarchy based on a second configuration. For example, the server may determine a parent resource and its child resource(s). In the present example, the parent resource is “order” and its child resource is “item.” According to a first example, the server may identify the hierarchy of the set of resources by using metadata. As described in more detail below, the metadata may be accessible to an engine processing the natural language queries, and the metadata may indicate directly or indirectly a hierarchy of resources stored in a table or other data storage format in addition to other information. According to a second example, the server may identify the hierarchy of the set of resources by using a set of rules such as transformation rules. In some examples, when no metadata is available, the server may use a list of known nouns and a list of known verbs (e.g., list of actions). When the nouns in the command are identified, the server may derive the respective parameters for each noun. In the example of natural language query “show me the price of item 2 of order 42,” the server may identify parameter “42” for noun “order,” parameter “2” for noun “item” and noun “price.” The server may then employ an iterative process to identify the hierarchy of the set of resources. Upon identifying the hierarchy of the set of resources, the techniques depicted herein provide for generation of a unique resource identifier of the target API to determine a value of the data record (“price” in the example of the natural language query “show me the price of item 2 of order 42”). Thus, the server may generate, from the natural language query and based on the hierarchy of the set of resources, the unique resource identifier for the target API to access the value of the one or more data records indicated in the query. This allows for automatic generation of a unique resource identifier in response to a natural language query, thereby improving the robustness of the system across different interfaces.

Aspects of the disclosure are initially described in the context of an environment supporting an on-demand database service. Aspects of the disclosure are further described with respect to a general system diagram that shows computing components and data flows that support generating unique resource identifiers and a process flow diagram illustrating various process and dataflows that support the techniques herein. Aspects of the disclosure are further illustrated by and described with reference to apparatus diagrams, system diagrams, and flowcharts that relate to methods to generate unique resource identifiers.

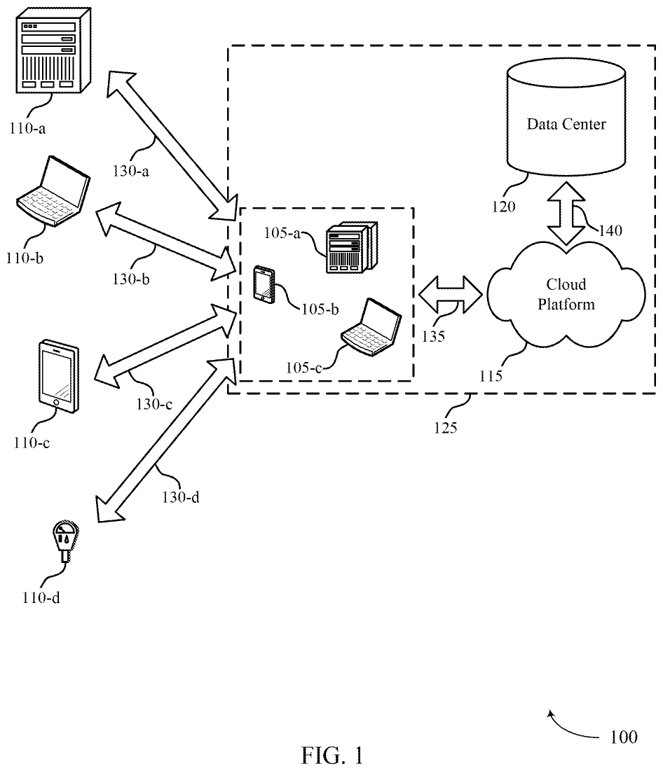

FIG. 1 illustrates an example of a system 100 for cloud computing that supports methods to generate unique resource identifiers in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The data center 120 may be an example of a multi-tenant system that supports data storage, retrieval, data analytics, and the like for various tenants, such as the cloud clients 105. As such, each cloud client 105 may be provided with a database instance in the datacenter 120, and each database instance may store various datasets that are associated with the particular cloud client 105. More particularly, each cloud client 105 may have a specific set of datasets that are unique for the cloud client 105. The cloud platform and datacenter 120 support a system that processes set of datasets for a particular cloud client 105. In some examples, the cloud platform and datacenter 120 support a system that receives a query (e.g., natural language query) from a particular cloud client 105 and generates a unique resource identifier for a target API based on the received query (e.g., mapped to the received query). As such, the unique resource identifier generated in response to an input query may be used to access a data record stored in a database. That is, the unique resource identifier generation may support a query to resource identifier conversion that enables the cloud client 105 to retrieve data from a database using natural language queries instead of queries that are specifically formatted for an API (e.g., a URI).

A database system may support storing data such that the stored data is accessible via REST API. REST APIs are designed as resource oriented APIs, where each resource is assigned a unique resource identifier. Although REST APIs are provided as an example, it is understood that other APIs may be used to retrieve data stored in a database or data table and that the described techniques of converting a natural language query into a query format usable by the API may be applicable to other API types. These unique resource identifiers are built such that an identifier for a parent record is the prefix of the unique resource identifier of its child records. As an example, the unique resource identifier “acme.com/shop/orders/42/item/2/price” may denote the price information for the second line item of the order number 42. In this example, “orders” is a parent record to the child record “item.” In general, REST APIs are easy to use by computer systems. However, it may be difficult for users to efficiently construct REST API unique resource identifiers or otherwise correctly construct a query usable by a REST API or similar API. Database systems may support searches using natural language queries. However, existing database systems may not support techniques for converting a natural language query to a query for a REST API or other API that stores and retrieves data in a similar hierarchical manner.

As described herein, the datacenter 120 and cloud platform 115 may support processing of natural language queries by utilizing machine learning models to generate a unique resource identifier in response to receiving a query from a user. Further, techniques described herein may support a unique resource identifier generation system that generates sets of resources and their corresponding values upon receiving an input query, learns hierarchical relationships between the set of resources, and generates a unique resource identifier upon receiving an input query based on the learned hierarchical relationships between the set of resources. Such techniques may automatically derive an accurate unique resource identifier for a resource from an input query received from a user.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

A cloud client 105 may be an example of a user device used by a user. The cloud client 105 may include a user interface such as a messaging interface for receiving a natural language query from the user. In one example, the system described herein may receive a query (e.g., a natural language query) “show me the price of item 2 of order 42.” The system may parse the natural language query to identify the resources “order” and “item.” The system also identifies parameters related to each resource. That is, in the natural language query “show me the price of item 2 of order 42,” the system may determine that “2” is the value of the resource “item” and “42” is the value of the resource “order.” The system then identifies a hierarchy of the set of resources. For example, the system may determine a parent resource and its child resource or resources. In the example depicted herein, the parent resource is “order” and its child resource is “item.” In some examples, the system may identify the hierarchy of the set of resources based on metadata and/or based on an iterative process. Upon identifying the hierarchy of the set of resources, the system may generate a unique resource identifier of a target API to determine a value of the data record. For example, the system may generate a unique resource identifier to determine the “price” in the example of the natural language query “show me the price of item 2 of order 42.”

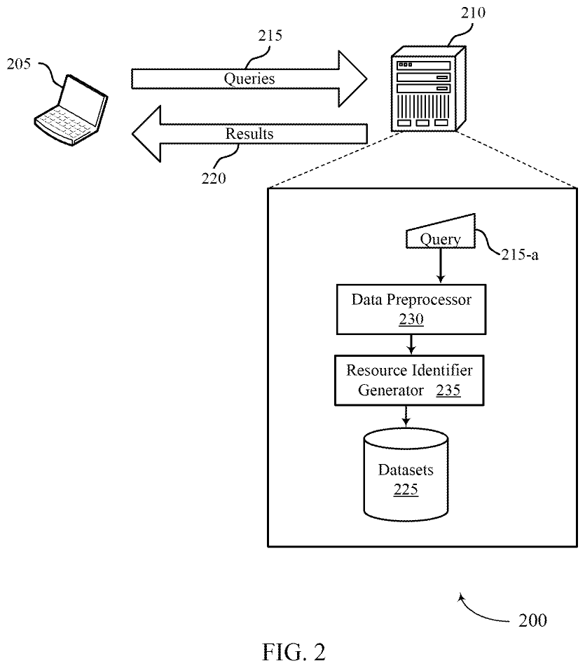

FIG. 2 illustrates an example of a computing system 200 that supports methods to generate unique resource identifiers in accordance with aspects of the present disclosure. The computing system 200 includes a user device 205 and a server 210. The user device 205 may be an example of a device associated with a cloud client 105 or contact 110 of FIG. 1. The server 210 may be examples of aspects of the cloud platform 115 and the datacenter 120 of FIG. 1. For example, the server 210 may represent various devices and components that support an analytical data system as described herein. The server 210 may support a multi-tenant database system, which may manage various datasets 225 that are associated with different tenants (e.g., cloud clients 105). In some examples, the datasets 225 may include a set of fields related to the tenant. The server 210 may also support data retrieval in response to queries 215 received from user devices, such as user device 205. The data retrieved in response to a query 215 may be surfaced to a user at the user device 205.

As described, the server 210 may manage various datasets 225 that are associated with specific tenants. For example, a datastore may store a set of datasets 225 that are associated with the tenant corresponding to user device 205. Each dataset of the set of datasets 225 may be a database table. To support techniques described herein, a data preprocessor 230 may identify a set of resources of the target API and a set of values corresponding to the set of resources. The set of resources may be associated with the dataset 225. The data preprocessor 230 may store at least one valid unique resource identifier in a cache of the server 210 (e.g., application server). In some examples, the data preprocessor 230 may identify a hierarchy of the set of resources of the target API. The hierarchy may be based on a configuration according to a first method (using metadata) or a second method (using transformation rules).

According to one or more aspects of the present disclosure, the dataset 225 may be associated with at least one of reports, report types, data objects, data sets, or a combination thereof. The dataset 225 may support storing data such that the stored data is accessible via an API such as a REST API. The server 210 may expose the data in the dataset 225 in form of REST APIs. As depicted herein, REST APIs are designed as resource-oriented APIs, where each resource is assigned a unique resource identifier. In some examples, a resource may include a customer data record, or an order record, or the line item of an order. The dataset 225 may include parent records (e.g. order) and one or more child records (e.g., line items). Some computer systems may expose their data in the form of REST APIs or other resource-oriented APIs. The resource-oriented APIs may include a unique resource identifier such that the identifier for a parent record (e.g. order) is the prefix of the unique resource identifier of its child records (e.g., the line items). As an example, the unique resource identifier “acme.com/shop/orders/42/item/2/price” denotes the price information for the second line item of the order no. 42. In some examples, the computing system 200 may support a command-based interface. Additionally or alternatively, the computing system 200 may support a mapping between existing REST APIs and messages in the form of natural language queries (such as “show me the price of item 2 of order 42”) inputted via the command-based interfaces.

According to aspects depicted herein, the data preprocessor 230 may receive a set of queries 215 (e.g., natural language queries). In some instances, each query of the set of queries may include a query for a value of one or more data records stored in a database, a database table, or any other structured data storage format. Additionally or alternatively, a query may include a value of all data records stored in a database table. In some examples, the data preprocessor 230 may parse each query of the set of queries to identify a set of resources of the target API and a set of values corresponding to the set of resources. The data preprocessor 230 may identify a query 215-a from the set of queries. For example, the data preprocessor 230 may identify a natural language query 215-a “show me the price of item 2 of order 42.”

The data preprocessor 230 may parse the natural language query to identify a set of resources and a set of values corresponding to the set of resources. For instance, the data preprocessor 230 may parse the natural language query to identify a set of resources of the target API and a set of values corresponding to the set of resources. The parsing operation may be based on a first configuration. In one example, the data preprocessor 230 may parse the natural language query to identify the resources “order” and “item.” The data preprocessor 230 may also identify parameters related to each resource. That is, in the natural language query “show me the price of item 2 of order 42,” the data preprocessor 230 may determine that “2” is the value of the resource “item” and “42” is the value of the resource “order.” The data preprocessor 230 may identify a hierarchy of the set of resources of the target API based on a second configuration. The second configuration may be based on a technique using metadata or a technique using transformation rules.

In some examples, some REST APIs may provide a mechanism to discover its capabilities from a (known) start point. According to the technique using metadata, the data preprocessor 230 may identify metadata associated with the target API based on receiving the natural language query. The data preprocessor 230 may then identify, according to the second configuration, a set of rules for determining the hierarchy of the set of resources of the target API based on the metadata associated with the target API. For instance, the data preprocessor 230 may identify a list of first-level resources from the set of resources included in the natural language query. Additionally or alternatively, the data preprocessor 230 may identify a second level resources based on a hierarchy of resources. For example, the data preprocessor 230 may identify a set of first level resources from the set of resources and a set of second level resources from the set of resources based on a set of rules for determining the hierarchy of the set of resources of the target API (e.g., the set of rules associated with the technique using metadata).

The data preprocessor 230 may determine a hierarchical relationship between the set of first level resources and the set of second level resources based on the set of rules. In the example of the natural language query “show me the price of item 2 of order 42,” the data preprocessor 230 may identify the resources “order,” “item,” and “price.” Thus, the data preprocessor 230 may parse the command inputted by the user, and detect which parts of the command (e.g., natural language query) denote a resource (‘show me the price of item 2 of order 42’). When the resource identifiers in a command are previously known, the data preprocessor 230 may derive the parameters specifying the exact resources. In the example depicted herein, the data preprocessor 230 may determine that the parent resource is “order” and its child resource is “item.” With this information, the data preprocessor 230 may build a unique resource identifier for the target API based on receiving the natural language query. In some examples, the unique resource identifier may include nouns as well as verbs (such as “/category/search/foo” or “/category_search/bar”). In some examples, the data preprocessor 230 may identify verbs in the natural language query. In addition, the data preprocessor 230 may identify one or more actions from the natural language query (e.g., an action in the query “show me category foo” is “/category/foo: whereas an action in the query “search for category bar” is “/category_search/bar”). For example, the data preprocessor 230 may determine, based on the metadata, that the natural language query includes an action from a list of actions. The resource identifier generator 235 may then generate, from the natural language query and based on the hierarchy of the set of resources, the unique resource identifier for the target API to access the value of the one or more data records indicated in the query. In the example where the data preprocessor 230 identifies an action in the natural language query, the resource identifier generator 235 may generate the unique resource identifier for the target API based on determining that the natural language query includes the action.

Additionally or alternatively, the data preprocessor 230 may identify the hierarchy of the set of resources by using a set of preconfigured rules such as transformation rules. In some examples, when no metadata describing the data structure or hierarchy of the target database is available, the data preprocessor 230 may use a list of known nouns (e.g., based on a dictionary or a user input list) and a list of known verbs (e.g., list of actions and list of verbs such as “get,” “show,” “search,” “find” “delete,” etc.). That is, when no metadata is available, the data preprocessor 230 may identify, according to the second configuration, a set of rules for utilizing a transformation to determine the hierarchy of the set of resources of the target API. Thus, the data preprocessor 230 may identify, based on the set of rules for utilizing a transformation, a list of nouns and a list of actions associated with the target API. Additionally or alternatively, the data preprocessor 230 may determine that the set of resources includes a first noun from the list of nouns and a second noun from the list of nouns. The data preprocessor 230 may then identify a first value corresponding to the first noun and a second value corresponding to the second noun. For instance, when the nouns in the command are identified, the data preprocessor 230 may derive the respective parameters for each noun. In the example of natural language query “show me the price of item 2 of order 42,” the data preprocessor 230 may identify the following parameter and noun pairs:
“order”—42
“item”—2 and
“price”

The data preprocessor 230 may then employ an iterative process to identify the hierarchy of the set of resources. For example, the data preprocessor 230 may send messages to the target API using different combinations of possible resource-value pairs to iteratively determine the hierarchy of the resources in the data table. Additionally or alternatively, the data preprocessor 230 may try different unique resource identifiers with an API and determine whether they denote a valid resource. For example, the data preprocessor 230 may perform the first test using a single noun as the following:
/order/42
/item/2
/price

When one of the options results in a valid resource, the data preprocessor 230 may test using additional nouns to construct a sub-resource. Assuming only “/order/42” was valid, the data preprocessor 230 may test using:
/order/42/price
/order/42/item/2

If both the options return valid results (with the former returning the total price of the order), the data preprocessor 230 may go on to test using
/order/42/price/item/2
/order/42/item/2/price

The third test may result in the second form being a valid resource. Thus, the data preprocessor 230 may iteratively generate, based on the set of transformation rules, a set of unique resource identifiers based on at least one of the first noun, the first value corresponding to the first noun, the second noun, the second value corresponding to the second noun, or a combination thereof. The data preprocessor 230 may also identify at least one valid unique resource identifier from the set of unique resource identifiers as depicted herein. In some examples, the data preprocessor 230 may store the at least one valid unique resource identifier in a cache of the application server 210 (so that upon receiving another natural language query, any invalid resource may be skipped). For example, the application server 210 may receive, via a user interface, a second natural language query indicating a query for the value of the one or more data records stored in the database table. The data preprocessor 230 may then identify the hierarchy of the set of resources included in the second natural language query based on the stored at least one valid unique resource identifier.

Upon identifying the hierarchy of the set of resources, the techniques depicted herein provide for generation of a unique resource identifier of the target API to determine a value of the data record (“price” in the example of the natural language query “show me the price of item 2 of order 42”). Thus, the resource identifier generator 235 may generate, from the natural language query and based on the hierarchy of the set of resources, the unique resource identifier for the target API to access the value of the one or more data records indicated in the query. The application server 210 may provide the generated unique resource identifier to a user. As such, the result 220 may include the generated unique resource identifier and may be returned to a user at the user device 205.

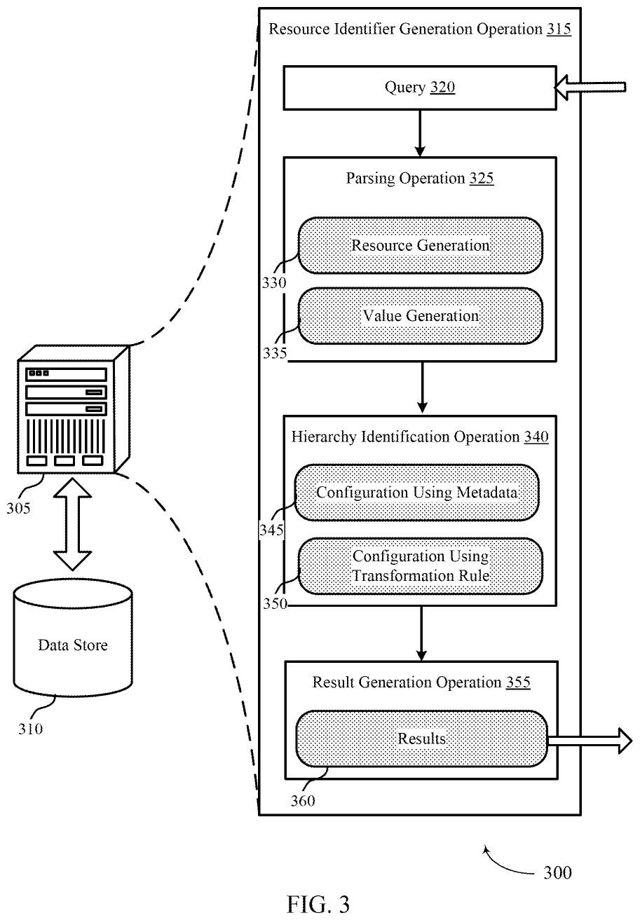

FIG. 3 illustrates an example of a computing system 300 that supports methods to generate unique resource identifiers in accordance with aspects of the present disclosure. The computing system 300 may include a device 305 (e.g., an application server) and a data store 310. In some cases, the functions performed by the device 305 (such as application server) may instead be performed by a component of the data store 310. A user device (not shown) may support an application for data analytics using machine learning models or other models. Specifically, a user device in combination with the device 305 may support an application that provides generating unique resource identifiers using data science and machine learning models. A user operating the user device may interact with the application to train a mathematical model (e.g., artificial intelligence model) at the device 305, where the device 305 may identify results 360 based on generating a unique resource identifier. In some examples, the device 305 may provide the results 360 to a user device (not shown).

According to one or more aspects of the present disclosure, a user device may optionally display an interactive interface for receiving a request (from a user) to run a machine learning model. In some examples, the user device may display the interactive interface for receiving a request (from a user) to train or develop an artificial intelligence model. Alternatively, the device 305 may train or develop a mathematical model (e.g., artificial intelligence model, a machine learning model, etc.) without receiving a request from a user device. In some cases, the interface at the user device may run as a webpage within a web browser (e.g., as a software as a service (SaaS) product). In other cases, the interface may be part of an application downloaded onto the user device. A user operating the user device may input information into the user interface to specify aspects of the request to develop an artificial intelligence model. In some cases, a user may be associated with a user credential or user ID, and the user may log on to the user device using the user credential. In certain aspects, the device 305 (or application server) may not have the requested artificial intelligence model developed at the device 305. Additionally or alternatively, the device 305 may determine a need to develop an artificial intelligence model (e.g., machine learning model) for generating a unique resource identifier. As described herein, the device 305 in conjunction with the data store 310 may perform a resource identifier generation operation 315.

According to one or more aspects of the present disclosure, the resource identifier generation operation 315 may be performed by the device 305, such as a server (e.g., an application server, a database server, a server cluster, a virtual machine, a container, etc.). Although not shown in FIG. 3, the resource identifier generation operation 315 may be performed by a user device, a data store 310, or some combination of these or similar devices. In some cases, the device 305 may be a component of a subsystem 125 as described with reference to FIG. 1. The device 305 may support computer aided data science, which may be performed by an artificial intelligence-enhanced data analytics framework. The device 305 may be an example of a general analysis machine and, as such, may perform data analytics and generation of unique resource identifiers for a target API based on receiving one or more queries.

According to one or more aspects of the present disclosure, the device 305 may receive a query 320 from one or more user devices (not shown). The device 305 may also receive a set of queries 320 from one or more user devices. In some examples, the queries may be natural language queries. Upon receiving the query 320, the device 305 may optionally convert the query to a query 320 executable at the device 305. The query 320 may be natural language query and may indicate a query for a value of one or more data records stored in a database table. The database table, as depicted herein, may be accessible via a target API that is configured as a resource oriented API. In some instances, the device 305 may perform a parsing operation 325 and a hierarchy identification operation 340. As part of the parsing operation 325, the device 305 may perform a resource generation operation 330 and a value generation operation 335. As part of the resource generation operation 330, the device 305 may parse, based on a first configuration, the natural language query to identify a set of resources of the target API. As part of the value generation operation 335, the device 305 may parse, based on a first configuration, the natural language query to identify a set of values corresponding to the set of resources. In some examples, the device may also identify metadata associated with the target API based on receiving the natural language query.

As part of the hierarchy identification operation 340, the device 305 may perform a hierarchy identification based on configuration using metadata 345 or a hierarchy identification based on configuration using transformation rule 350 or both. The device 305 may identify, based on a second configuration, a hierarchy of the set of resources of the target API. As part of the hierarchy identification based on configuration using metadata 345, the device 305 may identify, according to the second configuration, a set of rules for determining the hierarchy of the set of resources of the target API based on the metadata associated with the target API. The device 305 may identify a set of first level resources from the set of resources and a set of second level resources from the set of resources based on the set of rules. Additionally or alternatively, the device 305 may determine a hierarchical relationship between the set of first level resources and the set of second level resources based on the set of rules. In some examples, the device 305 may determine that the natural language query includes an action based on the metadata. In some examples, the action may be included in a list of actions previously known to the device.

As part of the hierarchy identification based on configuration using transformation rule 350, the device 305 may identify according to the second configuration, a set of rules for utilizing a transformation to determine the hierarchy of the set of resources of the target API. In some examples, the device 305 may identify, based on the set of rules, a list of nouns and a list of actions (or verbs) associated with the target API. The device 305 may further determine that the set of resources includes a first noun from the list of nouns and a second noun from the list of nouns. In some examples, the device 305 may identify a first value corresponding to the first noun and a second value corresponding to the second noun. The device 305 may iteratively generate, based on the set of rules, a set of unique resource identifiers based on at least one of the first noun, the first value corresponding to the first noun, the second noun, the second value corresponding to the second noun, or a combination thereof. That is, the device 305 may identify valid combination of nouns and values to determine a unique resource identifier. Additionally or alternatively, the device 305 may identify at least one valid unique resource identifier from the set of unique resource identifiers based on the iterative process. In some cases, the device 305 may store the at least one valid unique resource identifier in a cache of the device 305 for future use.

As part of the result generation operation 355, the device 305 may generate, from the natural language query and based on the hierarchy of the set of resources, the unique resource identifier for the target API to access the value of the one or more data records. That is, the device 305 may determine a unique resource identifier mapped to the natural language query for display. The device 305 may include the unique resource identifier in the results 360. In some examples, the results 360 may be displayed via a user interface.

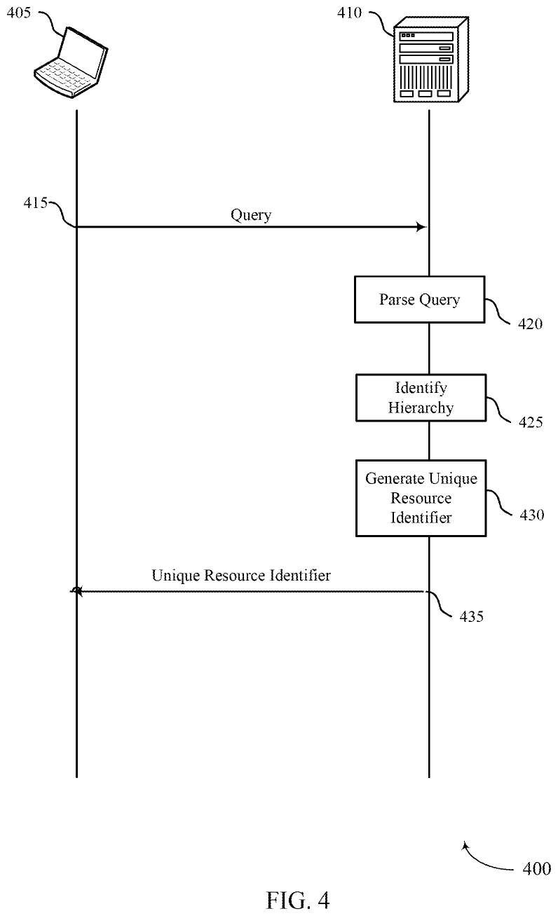

FIG. 4 illustrates an example of a process flow 400 that supports methods to generate unique resource identifiers in accordance with aspects of the present disclosure. The process flow diagram 400 includes a user device 405 and a server 410. The user device 405 may be an example of the user device 205 as described with respect to FIG. 2, and the server 410 may be an example of the server 210 as described with respect to FIG. 2. Although one user device 405 is depicted in the example of FIG. 4, it may be understood that the process flow 400 may include multiple user devices 405. The server may represent a set of computing components, data storage components, and the like, that support a multi-tenant database system as described herein. The process illustrated in FIG. 4 may be performed for various tenants of the multiple tenant system.

In some examples, the operations illustrated in the process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 415, the server 410 may receive a query (e.g., natural language query) via a user interface (e.g., a messaging interface or other command-based interface). The natural language query may indicate a query for a value of one or more data records stored in a database table or some other structure data storage format. In some examples, the database table may be accessible via a target API that is configured as a resource oriented API. The target API may include a REST API. In some examples, the server 410 may receive a set of queries where each query of the set of queries may be a natural language query.

At 420, the server 410 may parse the query (e.g., natural language query) to identify a set of resources of the target API and a set of values corresponding to the set of resources. In some instances, the server 410 may parse the natural language query based on a first configuration.

At 425, the server 410 may identify a hierarchy of the set of resources of the target API. The server 410 may identify the hierarchy based on a second configuration. In some examples, the server 410 may identify metadata associated with the target API based on receiving the natural language query. The server 410 may identify, according to the second configuration, a set of rules for determining the hierarchy of the set of resources of the target API based on the metadata associated with the target API. Additionally or alternatively, the server 410 may identify, according to the second configuration, a set of rules for utilizing a transformation to determine the hierarchy of the set of resources of the target API.

At 430, the server 410 may generate the unique resource identifier for the target API to access the value of the one or more data records. In some examples, the server 410 may generate the unique resource identifier from the natural language query and based on the hierarchy of the set of resources. At 435, the server 410 may transmit the generated unique resource identifier for display at the user device 405.

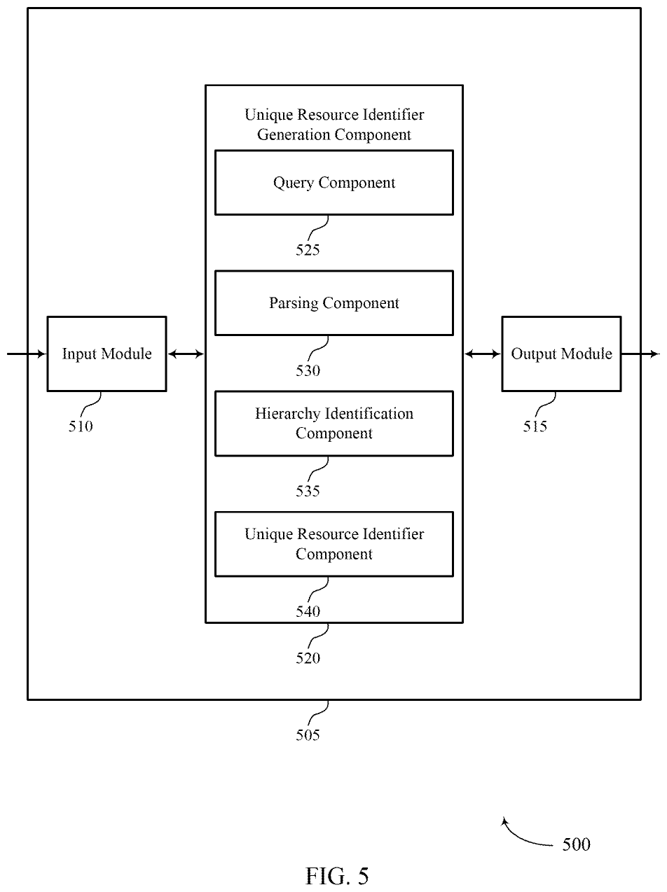

FIG. 5 shows a block diagram 500 of a device 505 that supports methods to generate unique resource identifiers in accordance with aspects of the present disclosure. The device 505 may include an input module 510, an output module 515, and a unique resource identifier generation component 520. The device 505 may also include a processor. Each of these components may be in communication with one another (e.g., via one or more buses).

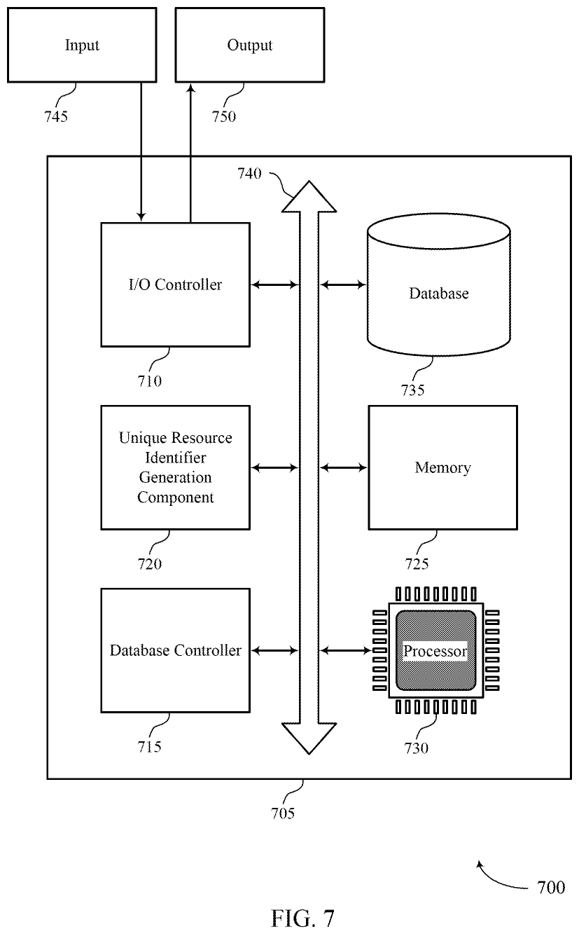

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the unique resource identifier generation component 520 to support methods to generate unique resource identifiers. In some cases, the input module 510 may be a component of an I/O controller 710 as described with reference to FIG. 7.

The output module 515 may manage output signals for the device 505. For example, the output module 515 may receive signals from other components of the device 505, such as the unique resource identifier generation component 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the unique resource identifier generation component 520 may include a query component 525, a parsing component 530, a hierarchy identification component 535, a unique resource identifier component 540, or any combination thereof. In some examples, the unique resource identifier generation component 520, or various components thereof, may be configured to perform various operations (e.g., receiving, monitoring, transmitting) using or otherwise in cooperation with the input module 510, the output module 515, or both. For example, the unique resource identifier generation component 520 may receive information from the input module 510, send information to the output module 515, or be integrated in combination with the input module 510, the output module 515, or both to receive information, transmit information, or perform various other operations as described herein.

The unique resource identifier generation component 520 may support generating a unique resource identifier at an application server in accordance with examples as disclosed herein. The query component 525 may be configured as or otherwise support a means for receiving, via a user interface, a natural language query indicating a query for a value of one or more data records stored in a database table, wherein the database table is accessible via a target API that is configured as a resource oriented API. The parsing component 530 may be configured as or otherwise support a means for parsing, based at least in part on a first configuration, the natural language query to identify a set of resources of the target API and a set of values corresponding to the set of resources. The hierarchy identification component 535 may be configured as or otherwise support a means for identifying, based at least in part on a second configuration, a hierarchy of the set of resources of the target API. The unique resource identifier component 540 may be configured as or otherwise support a means for generating, from the natural language query and based at least in part on the hierarchy of the set of resources, the unique resource identifier for the target API to access the value of the one or more data records.

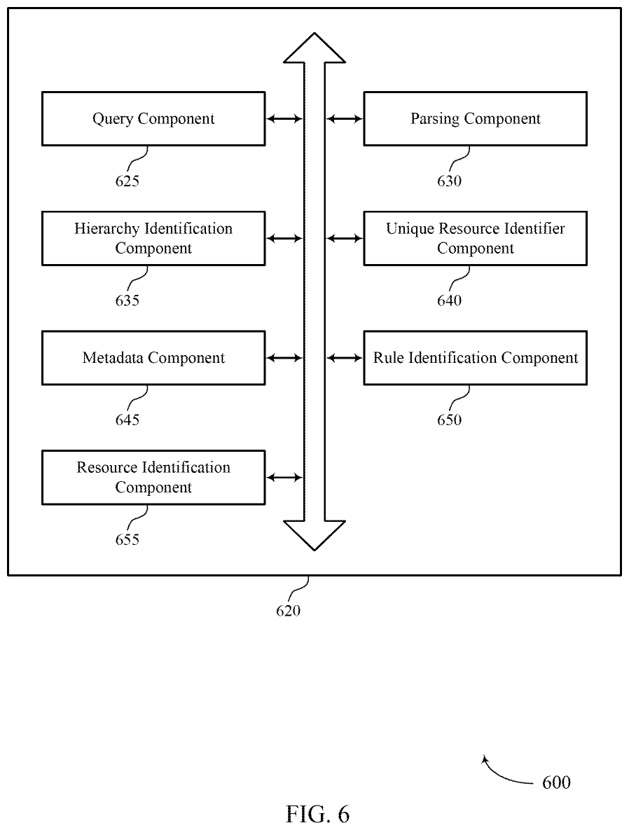

FIG. 6 shows a block diagram 600 of a unique resource identifier generation component 620 that supports methods to generate unique resource identifiers in accordance with aspects of the present disclosure. The unique resource identifier generation component 620 may be an example of aspects of a unique resource identifier generation component or a unique resource identifier generation component 520, or both, as described herein. The unique resource identifier generation component 620, or various components thereof, may be an example of means for performing various aspects of methods to generate unique resource identifiers as described herein. For example, the unique resource identifier generation component 620 may include a query component 625, a parsing component 630, a hierarchy identification component 635, a unique resource identifier component 640, a metadata component 645, a rule identification component 650, a resource identification component 655, or any combination thereof. Each of these components may communicate, directly or indirectly, with one another (e.g., via one or more buses).

The unique resource identifier generation component 620 may support generating a unique resource identifier at an application server in accordance with examples as disclosed herein. The query component 625 may be configured as or otherwise support a means for receiving, via a user interface, a natural language query indicating a query for a value of one or more data records stored in a database table, wherein the database table is accessible via a target API that is configured as a resource oriented API. The parsing component 630 may be configured as or otherwise support a means for parsing, based at least in part on a first configuration, the natural language query to identify a set of resources of the target API and a set of values corresponding to the set of resources. The hierarchy identification component 635 may be configured as or otherwise support a means for identifying, based at least in part on a second configuration, a hierarchy of the set of resources of the target API. The unique resource identifier component 640 may be configured as or otherwise support a means for generating, from the natural language query and based at least in part on the hierarchy of the set of resources, the unique resource identifier for the target API to access the value of the one or more data records.

In some examples, the metadata component 645 may be configured as or otherwise support a means for identifying metadata associated with the target API based at least in part on receiving the natural language query. In some examples, the hierarchy identification component 635 may be configured as or otherwise support a means for identifying, according to the second configuration, a set of rules for determining the hierarchy of the set of resources of the target API based at least in part on the metadata associated with the target API.

In some examples, the resource identification component 655 may be configured as or otherwise support a means for identifying a set of first level resources from the set of resources and a set of second level resources from the set of resources based at least in part on the set of rules. In some examples, the hierarchy identification component 635 may be configured as or otherwise support a means for determining a hierarchical relationship between the set of first level resources and the set of second level resources based at least in part on the set of rules.

In some examples, the unique resource identifier component 640 may be configured as or otherwise support a means for determining, based at least in part on the metadata, that the natural language query comprises an action from a list of actions, wherein generating the unique resource identifier for the target API is based at least in part on determining that the natural language query comprises the action.

In some examples, the rule identification component 650 may be configured as or otherwise support a means for identifying, according to the second configuration, a set of rules for utilizing a transformation to determine the hierarchy of the set of resources of the target API.

In some examples, the rule identification component 650 may be configured as or otherwise support a means for identifying, based at least in part on the set of rules, a list of nouns and a list of actions associated with the target API. In some examples, the rule identification component 650 may be configured as or otherwise support a means for determining that the set of resources comprises a first noun from the list of nouns and a second noun from the list of nouns. In some examples, the rule identification component 650 may be configured as or otherwise support a means for identifying a first value corresponding to the first noun and a second value corresponding to the second noun.

In some examples, the unique resource identifier component 640 may be configured as or otherwise support a means for generating, based at least in part on the set of rules, a plurality of unique resource identifiers based at least in part on at least one of the first noun, the first value corresponding to the first noun, the second noun, the second value corresponding to the second noun, or a combination thereof.

In some examples, the unique resource identifier component 640 may be configured as or otherwise support a means for identifying at least one valid unique resource identifier from the plurality of unique resource identifiers, wherein generating the unique resource identifier for the target API is based at least in part on identifying the at least one valid unique resource identifier.

In some examples, the unique resource identifier component 640 may be configured as or otherwise support a means for storing the at least one valid unique resource identifier in a cache of the application server. In some examples, the query component 625 may be configured as or otherwise support a means for receiving, via the user interface, a second natural language query indicating a query for the value of the one or more data records stored in the database table. In some examples, the hierarchy identification component 635 may be configured as or otherwise support a means for identifying the hierarchy of the set of resources included in the second natural language query based at least in part on the stored at least one valid unique resource identifier. In some examples, the target API comprises a REST API.

FIG. 7 shows a diagram of a system 700 including a device 705 that supports methods to generate unique resource identifiers in accordance with aspects of the present disclosure. The device 705 may be an example of or include the components of a device 505 as described herein. The device 705 may include components for bi-directional data communications including components for transmitting and receiving communications, such as a unique resource identifier generation component 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting methods to generate unique resource identifiers).

The unique resource identifier generation component 720 may support generating a unique resource identifier at an application server in accordance with examples as disclosed herein. For example, the unique resource identifier generation component 720 may be configured as or otherwise support a means for receiving, via a user interface, a natural language query indicating a query for a value of one or more data records stored in a database table, wherein the database table is accessible via a target API that is configured as a resource oriented API. The unique resource identifier generation component 720 may be configured as or otherwise support a means for parsing, basing at least in part on a first configuration, the natural language query to identify a set of resources of the target API and a set of values corresponding to the set of resources. The unique resource identifier generation component 720 may be configured as or otherwise support a means for identifying, based at least in part on a second configuration, a hierarchy of the set of resources of the target API. The unique resource identifier generation component 720 may be configured as or otherwise support a means for generating, from the natural language querying and basing at least in part on the hierarchy of the set of resources, the unique resource identifier for the target API to access the value of the one or more data records.

By including or configuring the unique resource identifier generation component 720 in accordance with examples as described herein, the device 705 may support techniques for improved communication reliability, reduced latency, and improved user experience related to reduced processing.

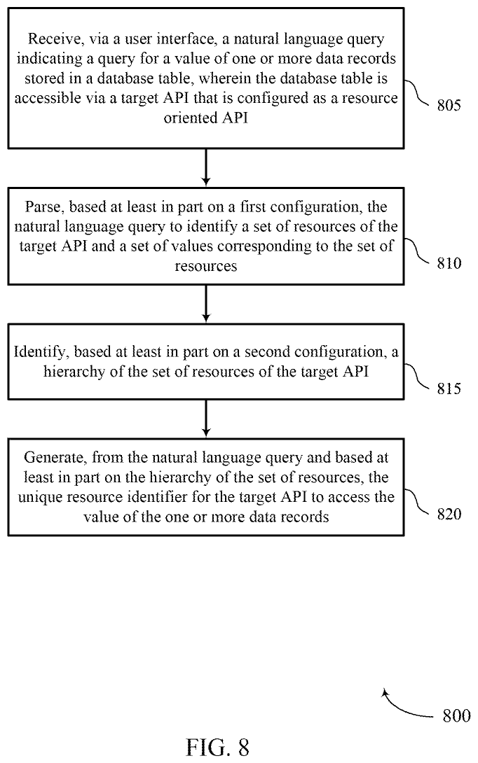

FIG. 8 shows a flowchart illustrating a method 800 that supports methods to generate unique resource identifiers in accordance with aspects of the present disclosure. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 805, the method may include receiving, via a user interface, a natural language query indicating a query for a value of one or more data records stored in a database table, wherein the database table is accessible via a target API that is configured as a resource oriented API. The operations of 805 may be performed in accordance with examples as disclosed herein. In some examples, aspects of the operations of 805 may be performed by a query component 625 as described with reference to FIG. 6.

At 810, the method may include parsing, based at least in part on a first configuration, the natural language query to identify a set of resources of the target API and a set of values corresponding to the set of resources. The operations of 810 may be performed in accordance with examples as disclosed herein. In some examples, aspects of the operations of 810 may be performed by a parsing component 630 as described with reference to FIG. 6.

At 815, the method may include identifying, based at least in part on a second configuration, a hierarchy of the set of resources of the target API. The operations of 815 may be performed in accordance with examples as disclosed herein. In some examples, aspects of the operations of 815 may be performed by a hierarchy identification component 635 as described with reference to FIG. 6.

At 820, the method may include generating, from the natural language query and based at least in part on the hierarchy of the set of resources, the unique resource identifier for the target API to access the value of the one or more data records. The operations of 820 may be performed in accordance with examples as disclosed herein. In some examples, aspects of the operations of 820 may be performed by a unique resource identifier component 640 as described with reference to FIG. 6.

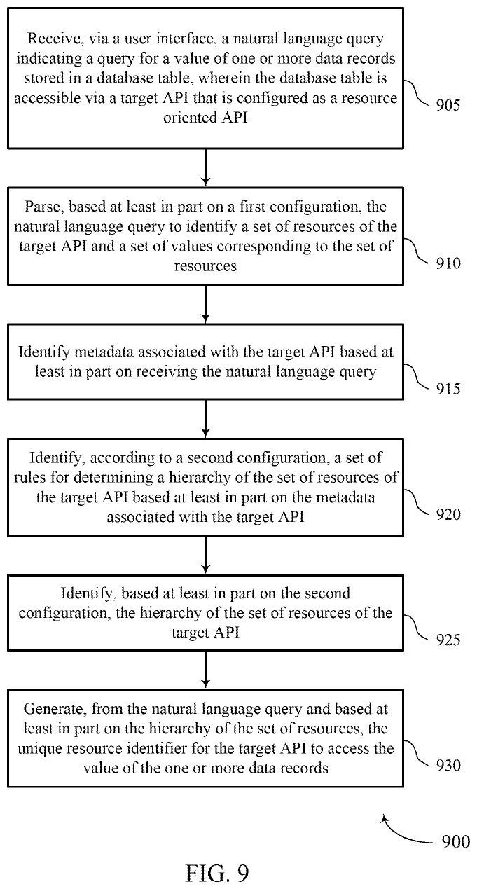

FIG. 9 shows a flowchart illustrating a method 900 that supports methods to generate unique resource identifiers in accordance with aspects of the present disclosure. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 905, the method may include receiving, via a user interface, a natural language query indicating a query for a value of one or more data records stored in a database table, wherein the database table is accessible via a target API that is configured as a resource oriented API. The operations of 905 may be performed in accordance with examples as disclosed herein. In some examples, aspects of the operations of 905 may be performed by a query component 625 as described with reference to FIG. 6.

At 910, the method may include parsing, based at least in part on a first configuration, the natural language query to identify a set of resources of the target API and a set of values corresponding to the set of resources. The operations of 910 may be performed in accordance with examples as disclosed herein. In some examples, aspects of the operations of 910 may be performed by a parsing component 630 as described with reference to FIG. 6.

At 915, the method may include identifying metadata associated with the target API based at least in part on receiving the natural language query. The operations of 915 may be performed in accordance with examples as disclosed herein. In some examples, aspects of the operations of 915 may be performed by a metadata component 645 as described with reference to FIG. 6.

At 920, the method may include identifying, according to a second configuration, a set of rules for determining the hierarchy of the set of resources of the target API based at least in part on the metadata associated with the target API. The operations of 920 may be performed in accordance with examples as disclosed herein. In some examples, aspects of the operations of 920 may be performed by a hierarchy identification component 635 as described with reference to FIG. 6.

At 925, the method may include identifying, based at least in part on the second configuration, the hierarchy of the set of resources of the target API. The operations of 925 may be performed in accordance with examples as disclosed herein. In some examples, aspects of the operations of 925 may be performed by a hierarchy identification component 635 as described with reference to FIG. 6.

At 930, the method may include generating, from the natural language query and based at least in part on the hierarchy of the set of resources, the unique resource identifier for the target API to access the value of the one or more data records. The operations of 930 may be performed in accordance with examples as disclosed herein. In some examples, aspects of the operations of 930 may be performed by a unique resource identifier component 640 as described with reference to FIG. 6.

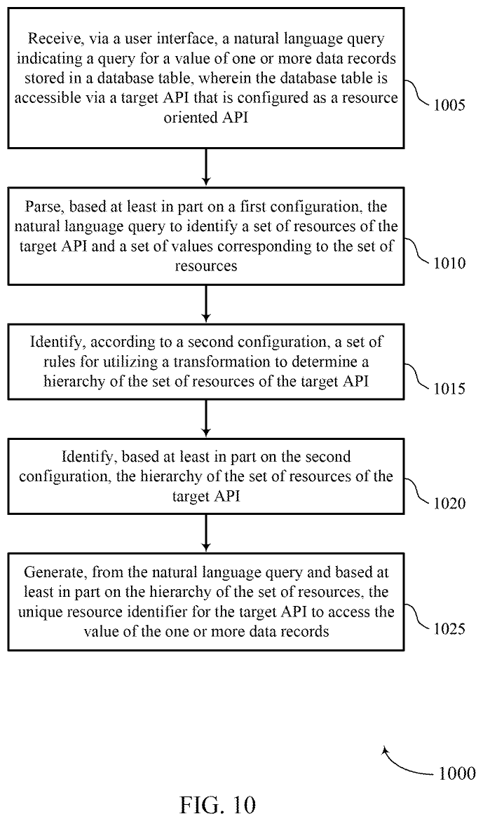

FIG. 10 shows a flowchart illustrating a method 1000 that supports methods to generate unique resource identifiers in accordance with aspects of the present disclosure. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1005, the method may include receiving, via a user interface, a natural language query indicating a query for a value of one or more data records stored in a database table, wherein the database table is accessible via a target API that is configured as a resource oriented API. The operations of 1005 may be performed in accordance with examples as disclosed herein. In some examples, aspects of the operations of 1005 may be performed by a query component 625 as described with reference to FIG. 6.

At 1010, the method may include parsing, based at least in part on a first configuration, the natural language query to identify a set of resources of the target API and a set of values corresponding to the set of resources. The operations of 1010 may be performed in accordance with examples as disclosed herein. In some examples, aspects of the operations of 1010 may be performed by a parsing component 630 as described with reference to FIG. 6.

At 1015, the method may include identifying, according to a second configuration, a set of rules for utilizing a transformation to determine a hierarchy of the set of resources of the target API. The operations of 1015 may be performed in accordance with examples as disclosed herein. In some examples, aspects of the operations of 1015 may be performed by a rule identification component 650 as described with reference to FIG. 6.

At 1020, the method may include identifying, based at least in part on the second configuration, the hierarchy of the set of resources of the target API. The operations of 1020 may be performed in accordance with examples as disclosed herein. In some examples, aspects of the operations of 1020 may be performed by a hierarchy identification component 635 as described with reference to FIG. 6.

At 1025, the method may include generating, from the natural language query and based at least in part on the hierarchy of the set of resources, the unique resource identifier for the target API to access the value of the one or more data records. The operations of 1025 may be performed in accordance with examples as disclosed herein. In some examples, aspects of the operations of 1025 may be performed by a unique resource identifier component 640 as described with reference to FIG. 6.

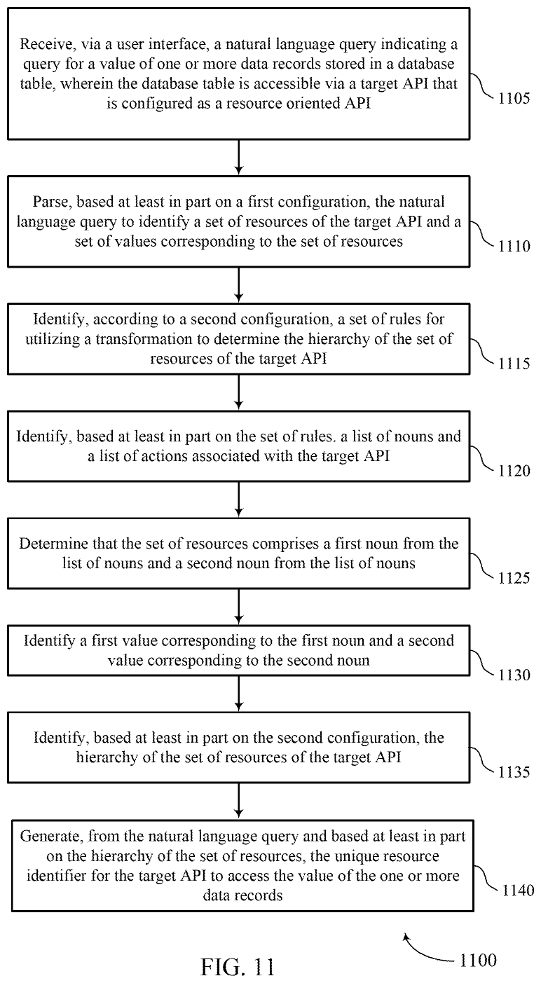

FIG. 11 shows a flowchart illustrating a method 1100 that supports methods to generate unique resource identifiers in accordance with aspects of the present disclosure. The operations of the method 1100 may be implemented by an application server or its components as described herein. For example, the operations of the method 1100 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1105, the method may include receiving, via a user interface, a natural language query indicating a query for a value of one or more data records stored in a database table, wherein the database table is accessible via a target API that is configured as a resource oriented API. The operations of 1105 may be performed in accordance with examples as disclosed herein. In some examples, aspects of the operations of 1105 may be performed by a query component 625 as described with reference to FIG. 6.

At 1110, the method may include parsing, based at least in part on a first configuration, the natural language query to identify a set of resources of the target API and a set of values corresponding to the set of resources. The operations of 1110 may be performed in accordance with examples as disclosed herein. In some examples, aspects of the operations of 1110 may be performed by a parsing component 630 as described with reference to FIG. 6.

At 1115, the method may include identifying, according to the second configuration, a set of rules for utilizing a transformation to determine the hierarchy of the set of resources of the target API. The operations of 1115 may be performed in accordance with examples as disclosed herein. In some examples, aspects of the operations of 1115 may be performed by a rule identification component 650 as described with reference to FIG. 6.

At 1120, the method may include identifying, based on the set of rules, a list of nouns and a list of actions associated with the target API. The operations of 1120 may be performed in accordance with examples as disclosed herein. In some examples, aspects of the operations of 1120 may be performed by a rule identification component 650 as described with reference to FIG. 6.

At 1125, the method may include determining that the set of resources comprises a first noun from the list of nouns and a second noun from the list of nouns. The operations of 1125 may be performed in accordance with examples as disclosed herein. In some examples, aspects of the operations of 1125 may be performed by a rule identification component 650 as described with reference to FIG. 6.

At 1130, the method may include identifying a first value corresponding to the first noun and a second value corresponding to the second noun. The operations of 1130 may be performed in accordance with examples as disclosed herein. In some examples, aspects of the operations of 1130 may be performed by a rule identification component 650 as described with reference to FIG. 6.

At 1135, the method may include identifying, based at least in part on a second configuration, a hierarchy of the set of resources of the target API. The operations of 1135 may be performed in accordance with examples as disclosed herein. In some examples, aspects of the operations of 1135 may be performed by a hierarchy identification component 635 as described with reference to FIG. 6.

At 1140, the method may include generating, from the natural language query and based at least in part on the hierarchy of the set of resources, the unique resource identifier for the target API to access the value of the one or more data records. The operations of 1140 may be performed in accordance with examples as disclosed herein. In some examples, aspects of the operations of 1140 may be performed by a unique resource identifier component 640 as described with reference to FIG. 6.

A method for generating a unique resource identifier at an application server is described. The method may include receiving, via a user interface, a natural language query indicating a query for a value of one or more data records stored in a database table, wherein the database table is accessible via a target API that is configured as a resource oriented API, parsing, based at least in part on a first configuration, the natural language query to identify a set of resources of the target API and a set of values corresponding to the set of resources, identifying, based at least in part on a second configuration, a hierarchy of the set of resources of the target API, and generating, from the natural language query and based at least in part on the hierarchy of the set of resources, the unique resource identifier for the target API to access the value of the one or more data records.

An apparatus for generating a unique resource identifier at an application server is described. The apparatus may include a processor, memory coupled with the processor, and instructions stored in the memory. The instructions may be executable by the processor to cause the apparatus to receive, via a user interface, a natural language query indicating a query for a value of one or more data records stored in a database table, wherein the database table is accessible via a target API that is configured as a resource oriented API, parsing, based at least in part on a first configuration, the natural language query to identify a set of resources of the target API and a set of values corresponding to the set of resources, identify, based at least in part on a second configuration, a hierarchy of the set of resources of the target API, and generating, from the natural language query and based at least in part on the hierarchy of the set of resources, the unique resource identifier for the target API to access the value of the one or more data records.

Another apparatus for generating a unique resource identifier at an application server is described. The apparatus may include means for receiving, via a user interface, a natural language query indicating a query for a value of one or more data records stored in a database table, wherein the database table is accessible via a target API that is configured as a resource oriented API, means for parsing, based at least in part on a first configuration, the natural language query to identify a set of resources of the target API and a set of values corresponding to the set of resources, means for identifying, based at least in part on a second configuration, a hierarchy of the set of resources of the target API, and means for generating, from the natural language query and based at least in part on the hierarchy of the set of resources, the unique resource identifier for the target API to access the value of the one or more data records.

A non-transitory computer-readable medium storing code for generating a unique resource identifier at an application server is described. The code may include instructions executable by a processor to receive, via a user interface, a natural language query indicating a query for a value of one or more data records stored in a database table, wherein the database table is accessible via a target API that is configured as a resource oriented API, parsing, based at least in part on a first configuration, the natural language query to identify a set of resources of the target API and a set of values corresponding to the set of resources, identify, based at least in part on a second configuration, a hierarchy of the set of resources of the target API, and generating, from the natural language query and based at least in part on the hierarchy of the set of resources, the unique resource identifier for the target API to access the value of the one or more data records.

Some examples of the method, apparatuses, and non-transitory computer-readable medium described herein may further include operations, features, means, or instructions for identifying metadata associated with the target API based at least in part on receiving the natural language query and identifying, according to the second configuration, a set of rules for determining the hierarchy of the set of resources of the target API based at least in part on the metadata associated with the target API.

Some examples of the method, apparatuses, and non-transitory computer-readable medium described herein may further include operations, features, means, or instructions for identifying a set of first level resources from the set of resources and a set of second level resources from the set of resources based at least in part on the set of rules and determining a hierarchical relationship between the set of first level resources and the set of second level resources based at least in part on the set of rules.

Some examples of the method, apparatuses, and non-transitory computer-readable medium described herein may further include operations, features, means, or instructions for determining, based at least in part on the metadata, that the natural language query comprises an action from a list of actions, wherein generating the unique resource identifier for the target API may be based at least in part on determining that the natural language query comprises the action.

Some examples of the method, apparatuses, and non-transitory computer-readable medium described herein may further include operations, features, means, or instructions for identifying, according to the second configuration, a set of rules for utilizing a transformation to determine the hierarchy of the set of resources of the target API.

Some examples of the method, apparatuses, and non-transitory computer-readable medium described herein may further include operations, features, means, or instructions for identifying, based at least in part on the set of rules, a list of nouns and a list of actions associated with the target API, determining that the set of resources comprises a first noun from the list of nouns and a second noun from the list of nouns, and identifying a first value corresponding to the first noun and a second value corresponding to the second noun.

In some examples of the method, apparatuses, and non-transitory computer-readable medium described herein, generating, based at least in part on the set of rules, a plurality of unique resource identifiers based at least in part on at least one of the first noun, the first value corresponding to the first noun, the second noun, the second value corresponding to the second noun, or a combination thereof.

Some examples of the method, apparatuses, and non-transitory computer-readable medium described herein may further include operations, features, means, or instructions for identifying at least one valid unique resource identifier from the plurality of unique resource identifiers, wherein generating the unique resource identifier for the target API may be based at least in part on identifying the at least one valid unique resource identifier. Some examples of the method, apparatuses, and non-transitory computer-readable medium described herein may further include operations, features, means, or instructions for storing the at least one valid unique resource identifier in a cache of the application server.

Some examples of the method, apparatuses, and non-transitory computer-readable medium described herein may further include operations, features, means, or instructions for receiving, via the user interface, a second natural language query indicating a query for the value of the one or more data records stored in the database table and identifying the hierarchy of the set of resources included in the second natural language query based at least in part on the stored at least one valid unique resource identifier. In some examples of the method, apparatuses, and non-transitory computer-readable medium described herein, the target API comprises a REST API.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for generating a unique resource identifier at an application server, comprising:
receiving, via a user interface, a natural language query indicating a query for a value of one or more data records stored in a database table, wherein the database table is accessible via a target application program interface (API) that is configured as a resource oriented API;
parsing, based at least in part on a first configuration, the natural language query to identify a set of resources of the target API and a set of values corresponding to the set of resources;
identifying, based at least in part on a second configuration, a hierarchy of the set of resources of the target API; and
generating, from the natural language query and based at least in part on the hierarchy of the set of resources, the unique resource identifier for the target API to access the value of the one or more data records.

2. The method of claim 1, further comprising:
identifying metadata associated with the target API based at least in part on receiving the natural language query; and
identifying, according to the second configuration, a set of rules for determining the hierarchy of the set of resources of the target API based at least in part on the metadata associated with the target API.

3. The method of claim 2, further comprising:
identifying a set of first level resources from the set of resources and a set of second level resources from the set of resources based at least in part on the set of rules; and
determining a hierarchical relationship between the set of first level resources and the set of second level resources based at least in part on the set of rules.

4. The method of claim 2, further comprising:
determining, based at least in part on the metadata, that the natural language query comprises an action from a list of actions, wherein generating the unique resource identifier for the target API is based at least in part on determining that the natural language query comprises the action.

5. The method of claim 1, further comprising:
identifying, according to the second configuration, a set of rules for utilizing a transformation to determine the hierarchy of the set of resources of the target API.

6. The method of claim 5, further comprising:
identifying, based at least in part on the set of rules, a list of nouns and a list of actions associated with the target API;
determining that the set of resources comprises a first noun from the list of nouns and a second noun from the list of nouns; and
identifying a first value corresponding to the first noun and a second value corresponding to the second noun.

7. The method of claim 6, further comprising:
generating, based at least in part on the set of rules, a plurality of unique resource identifiers based at least in part on at least one of the first noun, the first value corresponding to the first noun, the second noun, the second value corresponding to the second noun, or a combination thereof.

8. The method of claim 7, further comprising:
identifying at least one valid unique resource identifier from the plurality of unique resource identifiers, wherein generating the unique resource identifier for the target API is based at least in part on identifying the at least one valid unique resource identifier.

9. The method of claim 8, further comprising:
storing the at least one valid unique resource identifier in a cache of the application server.

10. The method of claim 9, further comprising:
receiving, via the user interface, a second natural language query indicating a query for the value of the one or more data records stored in the database table; and
identifying the hierarchy of the set of resources included in the second natural language query based at least in part on the stored at least one valid unique resource identifier.

11. The method of claim 1, wherein the target API comprises a representational state transfer (REST) API.

12. An apparatus for generating a unique resource identifier at an application server, comprising:
a processor;
memory coupled with the processor; and
instructions stored in the memory and executable by the processor to cause the apparatus to:
receive, via a user interface, a natural language query indicating a query for a value of one or more data records stored in a database table, wherein the database table is accessible via a target application program interface (API) that is configured as a resource oriented API;
parse, based at least in part on a first configuration, the natural language query to identify a set of resources of the target API and a set of values corresponding to the set of resources;
identify, based at least in part on a second configuration, a hierarchy of the set of resources of the target API; and
generate, from the natural language query and based at least in part on the hierarchy of the set of resources, the unique resource identifier for the target API to access the value of the one or more data records.

13. The apparatus of claim 12, wherein the instructions are further executable by the processor to cause the apparatus to:
identify metadata associated with the target API based at least in part on receiving the natural language query; and
identify, according to the second configuration, a set of rules for determining the hierarchy of the set of resources of the target API based at least in part on the metadata associated with the target API.

14. The apparatus of claim 13, wherein the instructions are further executable by the processor to cause the apparatus to:
identify a set of first level resources from the set of resources and a set of second level resources from the set of resources based at least in part on the set of rules; and
determine a hierarchical relationship between the set of first level resources and the set of second level resources based at least in part on the set of rules.

15. The apparatus of claim 13, wherein the instructions are further executable by the processor to cause the apparatus to:
determine, based at least in part on the metadata, that the natural language query comprises an action from a list of actions, wherein generating the unique resource identifier for the target API is based at least in part on determining that the natural language query comprises the action.

16. The apparatus of claim 12, wherein the instructions are further executable by the processor to cause the apparatus to:
identify, according to the second configuration, a set of rules for utilizing a transformation to determine the hierarchy of the set of resources of the target API.

17. The apparatus of claim 16, wherein the instructions are further executable by the processor to cause the apparatus to:
identify, based at least in part on the set of rules, a list of nouns and a list of actions associated with the target API;
determine that the set of resources comprises a first noun from the list of nouns and a second noun from the list of nouns; and
identify a first value corresponding to the first noun and a second value corresponding to the second noun.

18. The apparatus of claim 17, wherein the instructions are further executable by the processor to cause the apparatus to:
generate, based at least in part on the set of rules, a plurality of unique resource identifiers based at least in part on at least one of the first noun, the first value corresponding to the first noun, the second noun, the second value corresponding to the second noun, or a combination thereof.

19. The apparatus of claim 18, wherein the instructions are further executable by the processor to cause the apparatus to:
identify at least one valid unique resource identifier from the plurality of unique resource identifiers, wherein generating the unique resource identifier for the target API is based at least in part on identifying the at least one valid unique resource identifier.

20. A non-transitory computer-readable medium storing code for generating a unique resource identifier at an application server, the code comprising instructions executable by a processor to:
receive, via a user interface, a natural language query indicating a query for a value of one or more data records stored in a database table, wherein the database table is accessible via a target application program interface (API) that is configured as a resource oriented API;
parse, based at least in part on a first configuration, the natural language query to identify a set of resources of the target API and a set of values corresponding to the set of resources;
identify, based at least in part on a second configuration, a hierarchy of the set of resources of the target API; and
generate, from the natural language query and based at least in part on the hierarchy of the set of resources, the unique resource identifier for the target API to access the value of the one or more data records.
